(19) United States
(12) Patent Application Publication
(10) Pub. No.: US 2021/0355257 A1
(43) Pub. Date: Nov. 18, 2021

(54) POLYMER BINDERS FOR SILICON OR SILICON-GRAPHITE COMPOSITE ELECTRODES AND THEIR USE IN ELECTROCHEMICAL CELLS

(71) Applicants: HYDRO-QUÉBEC, Montréal, Québec (CA); MURATA MANUFACTURING CO., LTD., Nagaokakyo-shi, Kyoto (JP)

(72) Inventors: Jean-Christophe DAIGLE, St-Bruno-de-Montarville, Québec (CA); Birhanu Desalegn ASSRESAHEGN, Montréal, Québec (CA); Yuichiro ASAKAWA, Tokyo (JP); Karim ZAGHIB, Longueuil, Québec (CA)

(73) Assignees: HYDRO-QUÉBEC, Montréal, Québec (CA); MURATA MANUFACTURING CO., LTD., Nagaokakyo-shi, Kyoto (JP)

(21) Appl. No.: 17/274,257

(22) PCT Filed: Sep. 6, 2019
(86) PCT No.: PCT/CA2019/051253

§ 371 Date: Mar. 8, 2021

Related U.S. Application Data
(60) Provisional application No. 62/728,531, filed on Sep. 7, 2018.

(51) Int. Cl. C08F 216/06; C08F 220/20; C08F 220/06; H01M 4/62; H01M 4/38; H01M 4/583; H01M 4/133; H01M 4/134; C08J 3/075

(52) U.S. Cl. CPC C08F 216/06; C08F 220/20; C08F 220/06; H01M 4/622; C08K 5/1545; H01M 4/583; H01M 4/133; H01M 4/134; C08J 3/075; H01M 4/386

(57) ABSTRACT

Described are polymers, polymer binders, hydrogel polymer binders, hydrogel polymer binder compositions comprising them, electrode materials comprising them, their methods of production and their use in electrochemical cells, for instance, in silicon-based electrochemical cells.

### RELATED APPLICATION

This application claims priority under applicable laws to U.S. provisional application No. 62/728,531 filed on Sep. 7, 2018, the content of which is incorporated herein by reference in its entirety for all purposes.

### TECHNICAL FIELD

The technical field generally relates to polymers, polymer binders, hydrogel polymer binder compositions comprising them, electrode materials comprising them, their methods of production and their use in electrochemical cells.

### BACKGROUND

Silicon is one of the most promising negative electrode materials for future rechargeable batteries because of its high theoretical specific capacity of ˜4200 mAh/g upon formation of Li₁₅Si₄. A capacity which is approximately 10 times greater than conventional graphite negative electrodes (˜372 mAh/g) (see Liu, Y. et al., Accounts of chemical research 2017, 50.12, 2895-2905; and Hays, K. A. et al., Journal of Power Sources 2018, 384, 136-144). However, silicon negative electrodes experience severe volume expansion upon lithiation; thereby reaching more than 300% of their original volume and causing irremediable failure, pulverization and/or cracking, thus leading to a rapid capacity fading and to a significant cycle life reduction.

Several approaches have been suggested to overcome the capacity and stability issues associated with using conventional Si-based negative electrodes. For example, using silicon monoxide and/or its suboxides (i.e. SiOₓ) has been identified as one of the solutions to alleviate the volume expansion and to enhance cyclability. However, the capacity significantly decreases with an increase in oxygen content. Most solutions involved mixing silicon with carbon materials and/or polymer binders to contain the silicon. For instance, mixing Si or SiOₓ with graphite or graphene to form a Si-graphite or Si-graphene composite electrode has been proposed as a solution to accommodate volume change while maintaining an attractive capacity (see Hays, K. A. et al., Supra; Guerfi, A., et al., Journal of Power Sources 2011, 196.13, 5667-5673; and Loveridge, M. J., et al., Scientific Reports 2016, 6, 37787).

Poly(vinyl difluoride) (PVdF) is one of the most commonly used binders in commercial batteries, especially for batteries comprising graphite as a negative electrode. However, PVdF is not adequate for Si-based negative electrodes (See Hays, K. A. et al., Supra; Guerfi, A., et al., Supra; and Yoo, M. et al., Polymer 2003, 44.15, 4197-4204). Several binders have been used to absorb the change in volume during lithiation; for example, alginate (a polysaccharide derivative of cellulose) (see Kovalenko, I. et al., Science 2011, 334. 6052, 75-79), poly(acrylic acid) (PAA) (see Hays, K. A. et al., Supra; and Komaba, S. et al., The Journal of Physical Chemistry C 2011, 115.27, 13487-13495) and polyimide (PI) (see Guerfi, A., et al., Supra) have been applied with partial success.

Polymers bearing polar groups have been found useful for enhancing the mechanical adhesion and consequently preventing electrode degradation (see Kierzek, K., Journal of Materials Engineering and Performance 2016, 25.6, 2326-2330; and Ryou, M. H. et al., Advanced materials 2013, 25.11, 1571-1576). For example, PAA can neutralise Si surfaces to prevent side reactions. Hydroxyl groups on Si surfaces can also be neutralised, for example, via covalent bond formation through an esterification reaction (Zhao, H. et al., Nano Letters 2014, 14.11, 6704-6710).

Another solution would be coating Si-based materials with, for example, a self-healing polymer or a hydrogel. For instance, using a self-healing polymer coating, cracks and damage may be healed spontaneously. Self-healing polymer binders have been applied successfully in making Si negative electrodes with low loadings of active material (Wang, C. et al., Nature Chemistry 2013, 5, 1042). The reduction in loading allows a limitation in negative electrode volume expansion (around 1 mg/cm²). Stable Si-based negative electrodes were also obtained by in-situ polymerization of conducting hydrogel to form a conformal coating that binds to the Si surface. However, the loading in such materials is still very low (Wu, H. et al., Nature Communications 2013, 4, 1943).

Accordingly, there is a need to improve the capacity and/or stability of silicon based batteries despite the significant volume expansion upon lithiation of silicon negative electrodes.

### SUMMARY

According to one aspect, the present technology relates to a polymer comprising monomeric units from the polymerization of compounds of Formulae I and II:

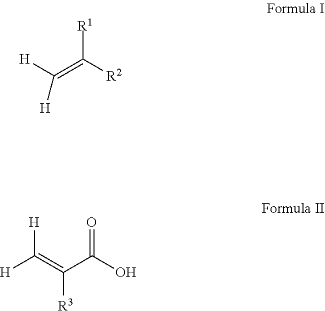

wherein,
R¹ is independently in each occurrence selected from —OH and a OH-containing group such as an optionally substituted C₁₋₆alkyl-OH or —CO₂C₁₋₆alkyl-OH; and
R² and R³ are each independently in each occurrence selected from a hydrogen atom and an optionally substituted C₁₋₆alkyl.

In one embodiment, the polymer is a copolymer of Formula III:

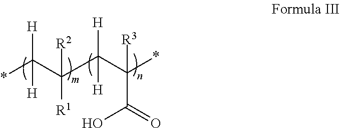

wherein,
R¹, R² and R³ are as defined herein; and
n and m are integers selected such that the number average molecular weight is from about 2 000 g/mol to about 250 000 g/mol.

In another embodiment, the copolymer as defined herein is an alternating copolymer, a random copolymer or a block copolymer.

According to another aspect, the present technology relates to an electrode material comprising the polymer as defined herein. In one embodiment, the electrode material further includes an electrochemically active material and a binder including the polymer.

According to another aspect, the present technology relates to an electrode material comprising the polymer as defined herein, an electrochemically active material, optionally a binder and optionally a polyphenol. In one embodiment, the electrode material includes the binder, said binder comprising the polymer as defined herein.

According to another aspect, the present technology relates an electrode material comprising an electrochemically active material, amylopectin, optionally a binder and optionally a polyphenol. In one embodiment, the electrode material includes the binder, said binder comprising amylopectin. In another embodiment, the binder further comprises the polyphenol.

According to another aspect, the present technology relates an electrode material including an electrochemically active material and a binder, said binder including amylopectin. In one embodiment, the binder further comprises a polyphenol.

According to another aspect, the present technology relates an electrode material including an electrochemically active material and a hydrogel binder, said hydrogel binder comprising a water-soluble polymeric binder and a polyphenol.

In one embodiment, the electrochemically active material is a silicon-based electrochemically active material. For instance, the silicon-based electrochemically active material is selected from the group consisting of silicon, silicon monoxide (SiO), a silicon suboxide (SiOₓ) and a combination thereof. For example, the silicon-based electrochemically active material is a silicon suboxide (SiOₓ) where x is 0<x<2.

In another embodiment, the silicon-based electrochemically active material further includes graphite or graphene.

In another embodiment, the polyphenol is selected from the group consisting of tannins, catechol and lignin. For example, wherein the polyphenol is a polyphenolic macromolecule. For instance, the polyphenolic macromolecule is tannic acid.

In another embodiment, the water-soluble polymeric binder includes a functional group selected from the group consisting of carboxyl group, carbonyl group, ether groups, amine groups, amide groups, and hydroxyl group. In one example, the water-soluble polymeric binder is a homopolymer. Alternatively, the water-soluble polymeric binder is a copolymer. For instance, the copolymer is an alternating copolymer, a random copolymer or a block copolymer.

In another embodiment, the water-soluble polymeric binder includes monomeric units of Formula V:

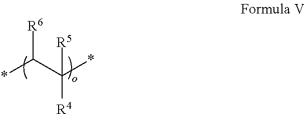

wherein,
R⁴ is independently in each occurrence selected from —CO₂H, —OH, an optionally substituted —CO₂C₁₋₆alkyl, an optionally substituted C₅₋₆ heterocycloalkyl, an optionally substituted —OC₁₋₆alkyl and an OH-containing functional groups such as an optionally substituted —C₁₋₆alkyl-OH or —CO₂C₁₋₆alkyl-OH;
R⁵ is independently in each occurrence selected from a hydrogen atom and an optionally substituted C₁₋₆alkyl;
R⁶ is independently in each occurrence selected from a hydrogen atom and an optionally substituted C₁₋₆alkyl; and
o is an integer selected such that the number average molecular weight is from about 2 000 g/mol to about 400 000 g/mol, or from about 2 000 g/mol to about 250 000 g/mol, or from about 25 000 g/mol to about 240 000 g/mol, or from about 27 000 g/mol to about 240 000 g/mol, limits included.

In another embodiment, the water-soluble polymeric binder is selected from the group consisting of poly(vinyl alcohol) (PVOH), poly(acrylic acid) (PAA), poly(vinylpyrrolidone) (PVP), poly(2-hydroxyethyl methacrylate-co-acrylic acid), poly(vinyl alcohol-co-acrylic acid), poly(acrylic acid-co-maleic acid) (PAAMA) polyethylene oxide (PEO), poly(methyl vinyl ether-alt-maleic acid) (PVMEMA), gelatin and polysaccharides.

According to another aspect, the present technology relates to a binder composition for use in an electrode material, the composition including a polyphenol and a water-soluble polymer.

In one embodiment, the polyphenol is selected from the group consisting of tannins, catechol and lignin. For instance, the polyphenol is tannic acid.

In another embodiment, the water-soluble polymer includes a functional group selected from the group consisting of carboxyl group, carbonyl group, ether groups, amine groups, amide groups, and hydroxyl group. In one example, the water-soluble polymer is a homopolymer. Alternatively, the water-soluble polymer is a copolymer. For instance, the copolymer is an alternating copolymer, a random copolymer or a block copolymer.

In another embodiment, the water-soluble polymer includes monomeric units of Formula V:

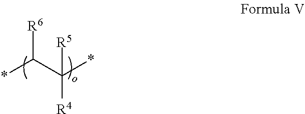

wherein,
R⁴ is independently in each occurrence selected from —CO₂H, —OH, an optionally substituted —CO₂C₁₋₆alkyl, an optionally substituted C₅₋₆ heterocycloalkyl, an optionally substituted —OC₁₋₆alkyl and an optionally substituted —CO₂C₁₋₆alkyl-OH;
R⁵ is independently in each occurrence selected from a hydrogen atom and an optionally substituted C₁₋₆alkyl;
R⁶ is independently in each occurrence selected from a hydrogen atom and an optionally substituted C₁₋₆alkyl; and
o is an integer selected such that the number average molecular weight is from about 2 000 g/mol to about 400 000 g/mol, or from about 2 000 g/mol to about 250 000 g/mol, or from about 25 000 g/mol to about 240 000 g/mol, or from about 27 000 g/mol to about 240 000 g/mol, limits included.

In another embodiment, the water-soluble polymer is selected from the group consisting of poly(vinyl alcohol) (PVOH), poly(acrylic acid) (PAA), poly(vinylpyrrolidone) (PVP), poly(2-hydroxyethyl methacrylate-co-acrylic acid), poly(vinyl alcohol-co-acrylic acid), poly(acrylic acid-co-maleic acid) (PAAMA), polyethylene oxide (PEO), poly(methyl vinyl ether-alt-maleic acid) (PVMEMA), gelatin and polysaccharides.

According to another aspect, the present technology relates to an electrode material including the binder composition as defined herein and an electrochemically active material.

According to another aspect, the present technology relates to an electrode material as defined herein on a current collector.

In one embodiment, the electrode is a negative electrode. Alternatively, the electrode is a positive electrode.

According to a further aspect, the present technology relates to an electrochemical cell including a negative electrode, a positive electrode and an electrolyte, wherein at least one of the negative electrode or positive electrode is as defined herein.

According to a further aspect, the present technology relates to a battery comprising at least one electrochemical cell as defined herein.

### BRIEF DESCRIPTION OF THE DRAWINGS

FIG. 1 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 1 as described in Example 4.

FIG. 2 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 2 as described in Example 4.

FIG. 3 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 3 as described in Example 4.

FIG. 4 displays a graph representing the capacity retention (%) versus the number of cycles for Cell 1 (white circle line) and Cell 2 (black circle line) as described in Example 4.

FIG. 5 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 4 as described in Example 4.

FIG. 6 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 5 as described in Example 4.

FIG. 7 displays four charge and discharge cycles, the first cycle was performed at 0.05 C (solid line) at a temperature of 25° C., the second cycle was performed at 0.1 C (dashed line) at a temperature of 25° C., the third cycle was performed at 0.2 C (dash dot line) at a temperature of 45° C. and the fourth cycle was performed at 0.2 C (dotted line) at a temperature of 45° C. for Cell 6 as described in Example 4.

FIG. 8 displays four charge and discharge cycles, the first cycle was performed at 0.05 C (solid line) at a temperature of 25° C., the second cycle was performed at 0.1 C (dashed line) at a temperature of 25° C., the third cycle was performed at 0.2 C (dash dot line) at a temperature of 45° C. and the fourth cycle was performed at 0.2 C (dotted line) at a temperature of 45° C. for Cell 7 as described in Example 4.

FIG. 9 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 8 as described in Example 4.

FIG. 10 displays three charge and discharge cycles, the first cycle was performed at 0.05 C (solid line), the second cycle was performed at 0.05 C (dashed line), and the third cycle was performed at 0.1 C (dotted line) at a temperature of 25° C. for Cell 9 as described in Example 4.

FIG. 11 displays four charge and discharge cycles, the first cycle was performed at 0.05 C (solid line) at a temperature of 25° C., the second cycle was performed at 0.1 C (dashed line) at a temperature of 25° C., the third cycle was performed at 0.2 C (dash dot line) at a temperature of 45° C. and the fourth cycle was performed at 0.2 C (dotted line) at a temperature of 45° C. for Cell 10 as described in Example 4.

FIG. 12 displays a graph representing the capacity retention (%) versus the number of cycles for Cell 4 (white triangle line), Cell 5 (black triangle line), Cell 8 (white circle line) and for Cell 9 (black circle line) as described in Example 4.

FIG. 13 displays a graph representing the capacity (mAh/g) versus the number of cycles for Cell 4 (white triangle line), Cell 5 (black triangle line), Cell 8 (white circle line) and for Cell 9 (black circle line) as described in Example 4.

FIG. 14 displays a graph representing the capacity retention (%) versus the number of cycles for Cell 7 (black triangle line), for Cell 4 (white triangle line), for Cell 1 (white square line) and for Cell 2 (black square line) as described in Example 4.

FIG. 15 displays a graph representing the capacity (mAh/g) versus the number of cycles for Cell 1 (white square line), for Cell 2 (black square line), for Cell 4 (white triangle line), and for Cell 7 (black triangle line) as described in Example 4.

FIG. 16 displays a graph representing the capacity retention (%) versus the number of cycles for Cell 10 (black circle line) and for Cell 6 (black triangle line) as described in Example 4.

FIG. 17 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 11.

FIG. 18 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 12.

FIG. 19 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 13.

FIG. 20 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 14.

FIG. 21 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 15.

FIG. 22 displays three charge and discharge cycles, the first cycle was performed at 0.05 C (solid line), the second cycle was performed at 0.05 C (dashed line) and the third cycle was performed at 0.1 C (dotted line) at a temperature of 25° C. for Cell 16.

### DETAILED DESCRIPTION

The following detailed description and examples are illustrative and should not be interpreted as further limiting the scope of the invention.

All technical and scientific terms and expressions used herein have the same definitions as those commonly understood by the person skilled in the art when relating to the present technology. The definition of some terms and expressions used herein is nevertheless provided below for clarity purposes.

When the term “approximately” or its equivalent term “about” are used herein, it means approximately or in the region of, and around. When the terms “approximately” or “about” are used in relation to a numerical value, it modifies it; for example, by a variation of 10% above and below its nominal value. This term may also take into account rounding of a number or the probability of random errors in experimental measurements, for instance due to equipment limitations.

For more clarity, the expression “monomeric units derived from” and equivalent expressions, as used herein, refers to polymer repeat units, which result from a polymerizable monomer after its polymerization.

The chemical structures described herein are drawn according to conventional standards. Also, when an atom, such as a carbon atom as drawn, seems to include an incomplete valency, then the valency is assumed to be satisfied by one or more hydrogen atoms even if they are not necessarily explicitly drawn.

As used herein, the term “alkyl” refers to saturated hydrocarbons having from one to six carbon atoms, including linear or branched alkyl groups. Examples of alkyl groups include, without limitation, methyl, ethyl, propyl, butyl, pentyl, hexyl, isopropyl, tert butyl, sec butyl, isobutyl, and the like. When the alkyl group is located between two functional groups, then the term alkyl also encompasses alkylene groups such as methylene, ethylene, propylene, and the like. The term “C₁-Cₙ alkyl” refers to an alkyl group having from 1 to the indicated “n” number of carbon atoms.

The terms “heterocycloalkyl” and equivalent expressions refer to a group comprising a saturated or partially unsaturated (non-aromatic) carbocyclic ring in a monocyclic system having from five to six ring members, where one or more ring members are substituted or unsubstituted heteroatoms (e.g. N, O, S, P) or groups containing such heteroatoms (e.g. NH, NR^{x} (where R^{x} is alkyl, acyl, aryl, heteroaryl or cycloalkyl), PO₂, SO, SO₂, and the like). Heterocycloalkyl groups may be C-attached or heteroatom-attached (e.g. via a nitrogen atom) where such is possible.

According to a first aspect, the present technology relates to a polymer comprising monomeric units from the polymerization of compounds of Formulae I and II:

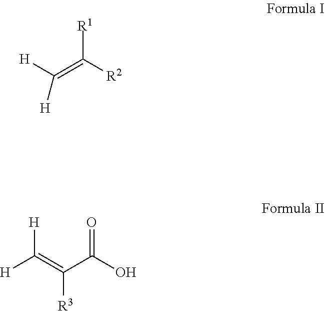

wherein,

R¹ is independently in each occurrence selected from —OH and a OH-containing group, e.g. an optionally substituted C₁₋₆alkyl-OH or —CO₂C₁₋₆alkyl-OH; and

R² and R³ are each independently in each occurrence selected from a hydrogen atom and an optionally substituted C₁₋₆alkyl.

For example, the polymer is a copolymer of Formula III:

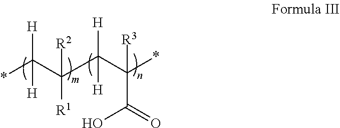

wherein R¹, R² and R³ are as herein defined; and n and m are integers selected such that the number average molecular weight is from about 2 000 g/mol to about 250 000 g/mol. For example, a number average molecular weight from about 10 000 g/mol to about 200 000 g/mol, or from about 25 000 g/mol to about 200 000 g/mol, or from about 25 000 g/mol to about 150 000 g/mol, or from about 50 000 g/mol to about 150 000 g/mol, or from about 75 000 g/mol to about 125 000 g/mol, limits included.

In some embodiments, the copolymer of Formula III may, for instance, be an alternating copolymer, a random copolymer or a block copolymer. For instance, the copolymer is a random copolymer or a block copolymer.

In some embodiments, the monomeric unit of Formula I is selected from vinyl alcohol, hydroxyethyl methacrylate (HEMA) and a derivative thereof.

In some embodiments, the monomeric unit of Formula II is selected from acrylic acid (AA), methacrylic acid (MA) and or a derivative thereof.

According to a variant of interest, the polymer is a copolymer comprising monomeric units derived from vinyl alcohol and from AA. According to another variant of interest, the copolymer comprises monomeric units derived from HEMA and from AA.

For example, the polymer is a copolymer of Formula III(a) or III(b):

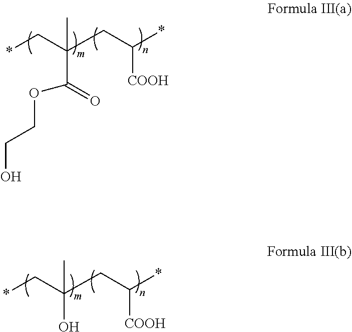

wherein m and n are as herein defined.

Polymerization of the monomers may be accomplished by any known procedure and method of initiation, for instance, by radical polymerization.

The radical initiator may any suitable polymerization initiator, such azo compounds (e.g. azobisisobutyronitrile (AIBN)). Polymerization may be further initiated by photolysis, thermal treatment, and any other suitable means. For instance, the initiator is AIBN.

Where the copolymer is a block copolymer, the synthesis may be achieved by reversible addition-fragmentation chain transfer polymerization (or RAFT).

According to another aspect, the present technology relates to an electrode material comprising the polymer as defined herein. In some embodiments, the electrode material comprises an electrochemically active material and further optionally comprises a binder. In some embodiments, the electrode material further comprises a polyphenol. For example, the binder comprises the polymer as defined herein and/or the polyphenol. It is understood that when the binder is said to comprise the polymer, it also includes the possibility of the polymer serving as the binder.

According to another aspect, the present technology relates to an electrode material comprising an electrochemically active material and amylopectin. In some embodiments, the electrode material further optionally comprises a binder. In some embodiments, the electrode material further comprises a polyphenol. For example, said binder comprises the amylopectin and/or the polyphenol.

According to another aspect, the present technology relates to a binder composition comprising a polyphenol and a water-soluble polymer.

According to another aspect, the present technology relates to an electrode material comprising electrochemically active material and a hydrogel binder, said hydrogel binder comprising a water-soluble polymeric binder and a polyphenol.

In some embodiments, the electrochemically active material is a silicon-based electrochemically active material. For example, the silicon-based electrochemically active material may comprise silicon, or silicon monoxide (SiO), or silicon oxide, or silicon suboxide (SiOₓ), or a combination thereof. For example, the silicon-based electrochemically active material comprises SiOₓ and x is 0<x<2, or 0.1<x<1.9, or 0.1<x<1.8, or 0.1<x<1.7, or 0.1<x<1.6, or 0.1<x<1.5, or 0.1<x<1.4, or 0.1<x<1.3, or 0.1<x<1.2, or 0.1<x<1.1, or 0.1<x<1.0, limits included. For instance, x is 0.1, or 0.2, or 0.3, or 0.4, or 0.5, 0.6, or 0.7, or 0.8. Higher concentrations of oxygen atoms in the SiOₓ electrochemically active material may also be considered as it may reduce its volume expansion upon lithiation but may also cause some capacity loss.

In some embodiments, the electrochemically active material further comprises a carbon material such as carbon, graphite and graphene. For instance, the graphite is a natural or artificial graphite, e.g. artificial graphite used as negative electrode material (such as SCMG™). For example, the electrochemically active material is a silicon carbon composite material, or a silicon graphite composite material or a silicon graphene composite material. In one variant of interest, the electrochemically active material is a SiOₓ graphite composite material. In some embodiments, the SiOₓ graphite composite material comprises up to about 100 wt. %, or up to about 95 wt. %, or up to about 90 wt. %, or up to about 75 wt. %, up to about 50 wt. %, or in the range between about 5 wt. % and about 100 wt. %, or between about 5 wt. % and about 95 wt. %, or between about 5 wt. % and about 90 wt. %, or between about 5 wt. % and about 90 wt. %, or between about 5 wt. % and about 85 wt. %, or between about 5 wt. % and about 80 wt. %, or between about 5 wt. % and about 75 wt. %, or between about 5 wt. % and about 70 wt. %, or between about 5 wt. % and about 65 wt. %, or between about 5 wt. % and about 60 wt. %, or between about 5 wt. % and about 55 wt. %, or between about 5 wt. % and about 50 wt. %, or between about 5 wt. % and about 45 wt. %, between about 5 wt. % and about 40 wt. %, or between about 5 wt. % and about 35 wt. %, or between about 5 wt. % and about 30 wt. %, or between about 5 wt. % and about 25 wt. %, or between about 5 wt. % and about 20 wt. %, or between about 5 wt. % and about 15 wt. %, or between about 5 wt. % and about 10 wt. %, limits included, of SiOₓ in the total weight of SiOₓ and graphite. The same concentrations may also further apply while replacing graphite with another carbon material.

In some embodiments, the electrochemically active material may further comprise a coating material. For example, the electrochemically active material may comprise a carbon coating. Alternatively, the coating material may also comprise at least one of the polymers as described herein, amylopectin and the water-soluble polymer as defined herein and further comprise the polyphenol. Alternatively, the coating material may comprise the hydrogel binder as defined herein.

In some embodiments, the polyphenol may be a gelling agent for hydrogel formation. The polyphenol may be a macromolecule including a sugar or sugar-like part linked to multiple polyphenolic groups (e.g. dihydroxyphenyl, trihydroxyphenyl, and their derivatives) or may be a polymer. For example, the polyphenol may be capable of gelling polymers or macromolecules at multiple binding sites through hydrogen bonding, effectively complexing polymer chains into three-dimensional (3D) networks.

The hydrogel binder as described herein is mainly formed through the H-bonding between the water-soluble polymeric binder and the polyphenol, which acts as strong interaction or physical cross-linking points thereby forming a 3D complex.

Non-limiting examples of polyphenol include tannins, lignin, catechol and tannic acid (TA). For example, the polyphenol is a polyphenolic macromolecule. In one variant of interest, the polyphenolic macromolecule is a tannin, for example, TA. TA is a natural polyphenol comprising the equivalent of ten gallic acid groups surrounding a monosaccharide (glucose) (see Formula IV). For instance, the twenty-five phenolic hydroxyl and ten ester groups of TA provide multiple binding sites to form hydrogen bonds with various water-soluble polymer binder chains having, for example, hydroxyl groups to form TA-based hydrogel binders.

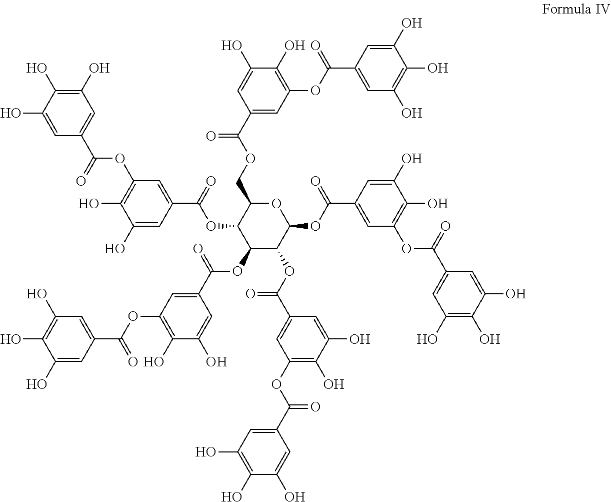 [SMILES: O=C(OC[C@H]1O[C@@H](OC(=O)c2cc(O)c(O)c(OC(=O)c3cc(O)c(O)c(O)c3)c2)[C@H](OC(=O)c2cc(O)c(O)c(OC(=O)c3cc(O)c(O)c(O)c3)c2)[C@@H](OC(=O)c2cc(O)c(O)c(OC(=O)c3cc(O)c(O)c(O)c3)c2)[C@@H]1OC(=O)c1cc(O)c(O)c(OC(=O)c2cc(O)c(O)c(O)c2)c1)c1cc(O)c(O)c(OC(=O)c2cc(O)c(O)c(O)c2)c1]

In one embodiment, the water-soluble polymeric binder may comprise carboxyl groups, carbonyl groups, ether groups, amine groups, amide groups, or hydroxyl groups to form hydrogen bonds with the polyphenol. Non-limiting examples of water-soluble polymeric binders include poly(vinyl alcohol) (PVOH), poly(acrylic acid) (PAA), polyvinylpyrrolidone (PVP), polyethylene oxide (PEO), poly(vinyl alcohol-co-acrylic acid), poly(methyl vinyl ether-alt-maleic acid) (PVMEMA), poly(acrylic acid-co-maleic acid) (PAAMA), poly(2-hydroxyethyl methacrylate-co-acrylic acid), polysaccharides, amylopectin, alginate gelatin, and a derivative thereof. In another embodiment, the water-soluble polymer comprises labile hydrogen atoms, for instance, on oxygen or nitrogen atoms, e.g. OH or CO₂H groups. For example, the water-soluble polymeric binder is PVOH, amylopectin or PAA.

For example, the water-soluble polymeric binder comprises the polymers of Formula V:

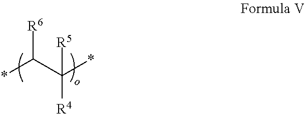

wherein,

R⁴ is independently in each occurrence selected from —CO₂H, —OH, an optionally substituted —CO₂C₁₋₆alkyl, an optionally substituted C₅₋₆ heterocycloalkyl, an optionally substituted —OC₁₋₆alkyl and an OH-containing functional group such as an optionally substituted —C₁₋₆alkyl-OH or —CO₂C₁₋₆alkyl-OH;

R⁵ is independently in each occurrence selected from a hydrogen atom and an optionally substituted C₁₋₆alkyl;

R⁶ is independently in each occurrence selected from a hydrogen atom and an optionally substituted C₁₋₆alkyl; and

o is an integer selected such that the number average molecular weight is from about 2 000 g/mol to about 400 000 g/mol, or from about 2 000 g/mol to about 250 000 g/mol, or from about 25 000 g/mol to about 250 000 g/mol, or from about 27 000 g/mol to about 250 000 g/mol, limits included.

For example, the water-soluble polymeric binder comprises the polymers of Formulae V(a), V(b) or V(c):

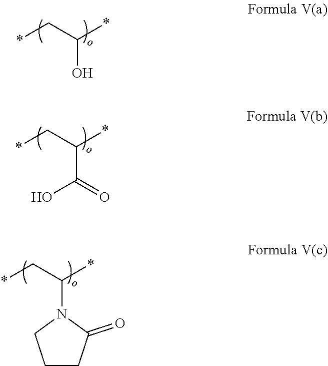

In some embodiments, the water-soluble polymeric binder is a homopolymer. Alternatively, the water-soluble polymeric binder is a copolymer. For instance, where the polymer is a copolymer, the copolymer may, for instance, be an alternating copolymer, a random copolymer or a block copolymer. In one variant, the copolymer is a random copolymer. In another variant, the copolymer is a bloc copolymer.

Alternatively, the water-soluble polymeric binder comprises the polymers of Formulae VI(a), VI(b) or VI(c):

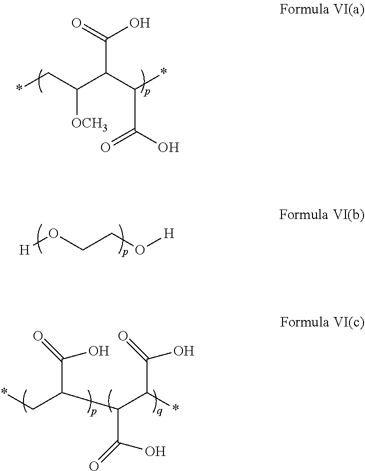

wherein p and q are integers independently selected such that the number average molecular weight is from about 2 000 g/mol to about 400 000 g/mol, or from about 2 000 g/mol to about 250 000 g/mol, or from about 25 000 g/mol to about 250 000 g/mol, or from about 27 000 g/mol to about 250 000 g/mol, limits included.

Alternatively, the water-soluble polymeric binder comprises a polysaccharide. For example, the water-soluble polymeric binder comprises the polymers of Formulae VII:

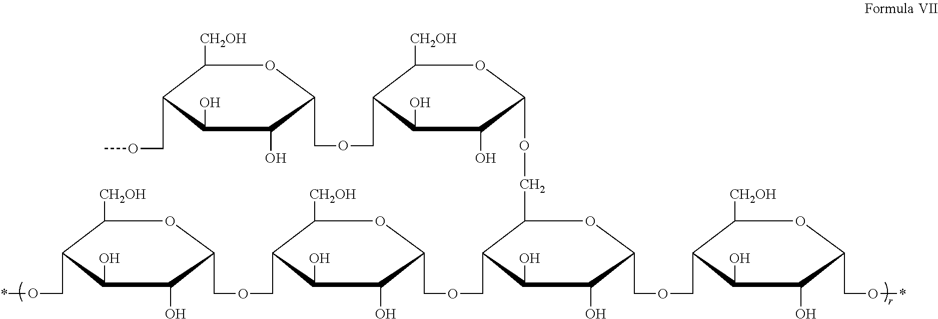

wherein r is an integer selected such that the number average molecular weight is from about 2 000 g/mol to about 400 000 g/mol, or from about 2 000 g/mol to about 250 000 g/mol, or from about 25 000 g/mol to about 250 000 g/mol, or from about 27 000 g/mol to about 250 000 g/mol, limits included. In some examples, polysaccharides may also further include derivatives thereof, for example, a carboxymethyl-substituted polysaccharide such as carboxymethylcellulose.

In some embodiments, the water-soluble polymeric binder has a number average molecular weight from about 2 000 g/mol to about 400 000 g/mol, or from about 2 000 g/mol to about 250 000 g/mol, or from about 25 000 g/mol to about 250 000 g/mol, or from about 27 000 g/mol to about 250 000 g/mol, limits included.

In some embodiments, the hydrogel binder comprises up to about 10 wt. % of the polyphenol. For example, the hydrogel binder comprises between about 1 wt. % and about 10 wt. %, or between about 1 wt. % and about 9 wt. %, or between about 1 wt. % and about 8 wt. %, or between about 1 wt. % and about 7 wt. %, or between about 1 wt. % and about 6 wt. %, 1 wt. % and about 5 wt. %, or between about 1 wt. % and about 4 wt. %, or between about 1 wt. % and about 3 wt. %, or between about 1 wt. % and about 2 wt. % of the polyphenol in the total weight of hydrogel binder (total weight including water, which may be removed after electrode formation). For instance, the hydrogel binder comprises about 2 wt. % of the polyphenol in the total weight of hydrogel binder.

In some embodiments, the hydrogel binder comprises between about 1 wt. % and about 30 wt. %, or between about 5 wt. % and about 25 wt. %, or between about 10 wt. % and about 25 wt. %, or between about 10 wt. % and about 20 wt. %, or between about 15 wt. % and about 20 wt. %, or between about 15 wt. % and about 17 wt. % of the polyphenol with respect to the total weight of the polyphenol and polymer. For instance, the hydrogel binder comprises a polymer to polyphenol weight ratio of about 10:2.

In some embodiments, the hydrogel binder comprises up to about 20 wt. % of the water-soluble polymeric binder. For example, the hydrogel binder comprises between about 1 wt. % and about 15 wt. %, or between about 5 wt. % and about 15 wt. %, or between about 7 wt. % and about 15 wt. %, or between about 8 wt. % and about 15 wt. %, or between about 9 wt. % and about 15 wt. %, or between about 9 wt. % and about 13 wt. %, or between about 9 wt. % and about 12 wt. %, or between about 9 wt. % and about 11 wt. %, limits included of the water-soluble polymeric binder in the total weight of hydrogel binder (total weight including water, which may be removed after electrode formation). For instance, the hydrogel binder comprises about 10 wt. % of the water-soluble polymeric binder.

In some embodiments, the hydrogel binder comprises water. For example, the hydrogel binder comprises at least about 60 wt. % of water prior to an optional drying step. For example, the hydrogel binder comprises between about 60 wt. % and about 98 wt. %, or between about 60 wt. % and about 98 wt. %, or between about 64 wt. % and about 98 wt. %, or between about 70 wt. % and about 98 wt. %, or between about 75 wt. % and about 98 wt. %,or between about 80 wt. % and about 98 wt. %, or between about 80 wt. % and about 95 wt. %, or between about 82 wt. % and about 95 wt. %, or between about 83 wt. % and about 94 wt. %, or between about 84 wt. % and about 93 wt. %, or between about 85 wt. % and about 92 wt. %, or between about 86 wt. % and about 91 wt. %, or between about 87 wt. % and about 90 wt. %, limits included of water prior to the optional drying step. For instance, the hydrogel binder comprises about 88 wt. % of water prior to the optional drying step.

In some embodiments, the hydrogel is a bio-based hydrogel. For instance, the hydrogel binders show, for example, improved mechanical performances, improved flexibility, improved elasticity, improved stretchability, improved self-healing properties, improved adhesive properties, and/or improved shape memory properties. For instance, the hydrogel binders may exhibit improved tensile strengths and/or elongations and/or elastic moduli. Furthermore, the hydrogel binders may be readily commercialized, since large amounts of hydrogel binders may be easily prepared given that no complicated synthetic procedure is involved. In such bio-based hydrogels, the polymer is, for instance, amylopectin or gelatin. In one variant of interest, the hydrogel comprises amylopectin.

In some embodiments, the electrode material as described herein may further comprise an electronically conductive material. The electrode material may also optionally include additional components or additives like salts, inorganic particles, glass or ceramic particles, and the like.

Non-limiting examples of electronically conductive material include carbon black (e.g. Ketjen™ black), acetylene black (e.g. Shawinigan black and Denka™ black), graphite, graphene, carbon fibers, carbon nanofibers (e.g. vapor grown carbon fibers (VGCF)), carbon nanotubes (CNTs), and combinations thereof. For example, the electronically conductive material is a combination of Ketjen™ black and VGCF.

According to another aspect, the present technology relates to an electrode comprising the electrode material as defined herein on a current collector. For example, the electrode is a negative electrode or a positive electrode. In one variant of interest, the electrode is a negative electrode.

According to a further aspect, the present technology relates to an electrochemical cell comprising a negative electrode, a positive electrode and an electrolyte, wherein at least one of the negative electrode or positive electrode is as defined herein. For example, the negative electrode is as defined herein.

In some embodiments, the electrolyte may be a liquid electrolyte comprising a salt in a solvent, or a gel electrolyte comprising a salt in a solvent which may further comprise a solvating polymer or a solid polymer electrolyte comprising a salt in a solvating polymer. In one variant on interest, the salt is a lithium salt.

Non-limiting examples of lithium salt include lithium hexafluorophosphate (LiPF₆), lithium bis (trifluoromethanesulfonyl) imide (LiTFSI), lithium bis (fluorosulfonyl) imide (LiFSI), lithium 2-trifluoromethyl-4,5-dicyanoimidazolate (LiTDI), lithium 4,5-dicyano-1,2,3-triazolate (LiDCTA), lithium bis (pentafluoroethylsulfonyl) imide (LiBETI), lithium tetrafluoroborate (LiBF₄), lithium bis (oxalato) borate (LiBOB), lithium nitrate (LiNO₃), lithium chloride (LiCl), bromide of lithium (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li [PF₃(CF₂CF₃)₃] (LiFAP), lithium tetrakis (trifluoroacetoxy) borate Li[B(OCOCF₃)₄] (LiTFAB), lithium bis (1,2-benzenediolato (2-)-O,O′) borate [B(C₆O₂)₂] (LBBB) and combinations thereof. According to one variant of interest, the lithium salt is lithium hexafluorophosphate (LiPF₆).

For example, the solvent is a non-aqueous solvent. Non-limiting examples of non-aqueous solvents include cyclic carbonates such as ethylene carbonate (EC), propylene carbonate (PC), butylene carbonate (BC), and vinylene carbonate (VC); acyclic carbonates such as dimethyl carbonate (DMC), diethyl carbonate (DEC), ethylmethyl carbonate (EMC), and dipropyl carbonate (DPC); lactones such as γ-butyrolactone (γ-BL) and γ-valerolactone (γ-VL); chain ethers such as 1,2-dimethoxyethane (DME), 1,2-diethoxyethane (DEE), ethoxymethoxyethane (EME), trimethoxymethane, and ethylmonoglyme; cyclic ethers such as tetrahydrofuran, 2-methyltetrahydrofuran, 1,3-dioxolane and dioxolane derivatives; and other solvents such as dimethylsulfoxide, formamide, acetamide, dimethylformamide, acetonitrile, propylnitrile, nitromethane, phosphoric acid triester, sulfolane, methylsulfolane, propylene carbonate derivatives, and mixtures thereof. According to one variant of interest, the solvent is an alkyl carbonate (acyclic or cyclic) or a mixture of two or more carbonates such as EC/EMC/DEC (4:3:3).

In some embodiments, the electrolyte may also include at least one electrolyte additive, for example, to form a stable solid electrolyte interphase (SEI) and/or to improve the cyclability of silicon based electrochemically active material. In a variant of interest, the electrolyte additive is fluoroethylene carbonate (FEC).

In some embodiments, the electrochemical cell as defined herein may have improved electrochemical performance (e.g. improved cyclability).

According to a further aspect, the present technology relates to a battery comprising at least one electrochemical cell as defined herein. For example, said battery is selected from a lithium battery, a lithium-sulfur battery, a lithium-ion battery, a sodium battery, and a magnesium battery. In one variant of interest, said battery is a lithium-ion battery.

### EXAMPLES

The following non-limiting examples are illustrative embodiments and should not be construed as further limiting the scope of the present invention. These examples will be better understood when referring to the accompanying Figures.

### Example 1

### Polymer Synthesis

a) Random Copolymerization of AA and HEMA

The random copolymer was prepared following a copolymerization process as illustrated in Scheme 1:

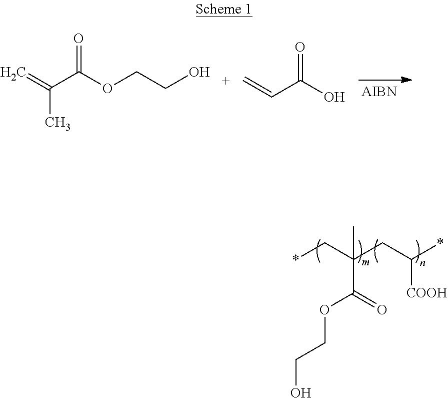

wherein n and m are as herein defined.

Following the process of Scheme 1, HEMA was first passed through basic aluminum oxide (alumina, Al₂O₃) and AA was distilled under reduced pressure. To perform this copolymerization, 7.2 g of HEMA, 4.0 g of AA and 100 mL of N,N-dimethylformamide (DMF) were introduced in a round-bottomed flask. The solution was then bubbled with nitrogen for 30 minutes to remove oxygen. Azobisisobutyronitrile (AIBN, 48 mg) was then added and the solution was heated to 70° C. under nitrogen for at least 12 hours. The polymer was then purified by precipitation in 10 volumes of toluene or diethyl ether, separated and dried under vacuum for 12 hours.

b) Block Copolymerization of AA and HEMA

The block copolymer was prepared by a two-steps RAFT copolymerization process as illustrated in Scheme 2:

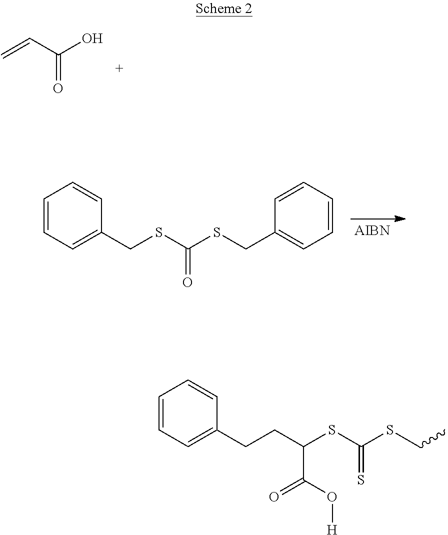

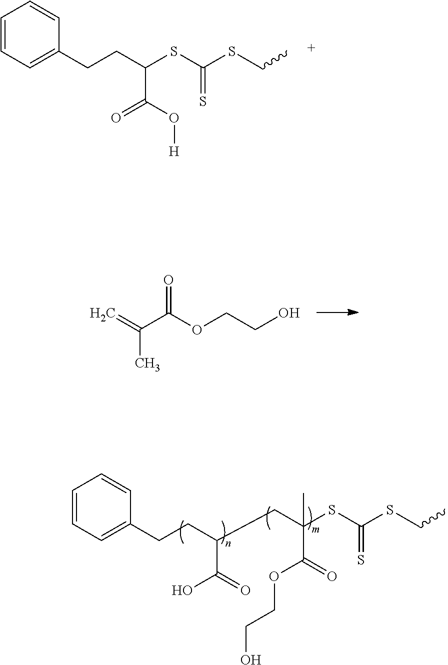

wherein n and m are as herein defined.

Formation of the PAA Block

The first step comprises the polymerization of AA by RAFT polymerization to form a first block comprising AA monomer units. In this first step, 10.0 g of AA, 38.5 mg of S,S-dibenzyl trithiocarbonate (RAFT CTA) and 100 mL of dioxane were introduced in a round-bottomed flask. The solution was then stirred at room temperature and bubbled with nitrogen for 30 minutes to remove oxygen. 77.0 mg of AIBN was added and the solution was heated to a temperature of 85° C. under nitrogen for at least 3 hours.

The polymer was then purified by precipitation in 10 volumes of toluene and dried under vacuum for 12 hours at 80° C. A standard production yield obtained in the first step of this procedure was about 7.6 g.

Formation of poly(HEMA) Block and Copolymerization

The second step comprises the formation of a second block comprising HEMA monomer units. In this second step, 6.0 g of the previous polymer (PAA-RAFT), 13.0 g of HEMA and 250 ml of DMF were added in a round-bottomed flask. The solution was stirred at room temperature and bubbled with nitrogen for 30 minutes to remove oxygen. 75 mg of AIBN was then added to the reaction mixture and the solution was heated to a temperature of 65° C. under nitrogen for at least 12 hours. The polymer was then purified by precipitation in 10 volumes of diethyl ether and hexanes (3:1) and dried under vacuum for 12 hours.

### Example 2

### Water-Soluble Polymer-TA Hydrogel Binder Preparation

a) PVOH-TA Hydrogel Binder Preparation

This example illustrates the preparation of a TA and PVOH hydrogel binder. An aqueous binder solution was prepared by dissolving 10 wt. % of PVOH (M.W. ˜27 000 g/mol) from Millipore Sigma™ and 2 wt. % of TA in water at a temperature of 60° C. The mixture was then cooled to room temperature thereby effectively creating strong H-bonding between the TA and the PVOH and weaker H-bonding between the PVOH chains and forming a PVOH-TA hydrogel.

b) Random poly(2-hydroxyethyl methacrylate-co-acrylic acid)—TA Hydrogel Binder Preparation

This example illustrates the preparation of a TA and the copolymer of Example 1(a) hydrogel binder. An aqueous binder solution was prepared by dissolving 12 wt. % of the copolymer of Example 1(a) and 4 wt. % of TA in an aqueous-ethanol mixture (20 wt. %) at a temperature of 60° C., the ethanol being added prior to the addition of TA. The mixture was then cooled to room temperature thereby effectively creating strong H-bonding between the TA and the copolymer of Example 1(a) and weaker H-bonding between the copolymer of Example 1(a) chains and forming a hydrogel.

c) Bloc poly(2-hydroxyethyl methacrylate-co-acrylic acid)—TA Hydrogel Binder Preparation

This example illustrates the preparation of a TA and the copolymer of Example 1(b) hydrogel binder. An aqueous binder solution was prepared by dissolving 12 wt. % of the copolymer of Example 1(b) and 4 wt. % of TA in an aqueous-ethanol mixture (20 wt. %) at a temperature of 60° C., the ethanol being added prior to the addition of TA. The mixture to room temperature thereby effectively creating strong H-bonding between the TA and the copolymer of Example 1(b) and weaker H-bonding between the copolymer of Example 1(b) chains and forming a hydrogel.

d) PAA-TA Hydrogel Binder Preparation

This example illustrates the preparation of a TA and PAA hydrogel binder. An aqueous binder solution was prepared by dissolving 10 wt. % of PAA (25 wt. % solution in water; M.W. ˜240 000 g/mol) from Acros Organics™ and 5 wt. % of TA in water at a temperature of 60° C. The mixture was then cooled to room temperature thereby effectively creating strong H-bonding between the TA and the PAA and weaker H-bonding between the PAA chains and forming a PAA-TA hydrogel.

Hydrogel binder composition comprising 10 wt. % of PAA and 2 wt. % of TA and hydrogel binder composition comprising 10 wt. % of PAA and 1 wt. % of TA were also prepared using the method described in Example 1 (d).

e) PVP-TA Hydrogel Binder Preparation

This example illustrates the preparation of a TA and PVP hydrogel. An aqueous binder solution was prepared by dissolving 10 wt. % of PVP (M.W. ˜29 000 g/mol) from Millipore Sigma™ and 1 wt. % of TA in water at a temperature of 60° C. The mixture was then cooled to room temperature thereby effectively creating strong H-bonding between the TA and the PVP and weaker H-bonding between the PVP chains and forming a PVP-TA hydrogel.

f) Amylopectin-TA Hydrogel Binder Preparation

This example illustrates the preparation of a TA and amylopectin hydrogel binder. An aqueous binder solution was prepared by dissolving 7 wt. % of amylopectin and 1 wt. % of TA in water at a temperature of 60° C. The mixture was then cooled to room temperature thereby effectively creating strong H-bonding between the TA and the amylopectin and weaker H-bonding between the amylopectin chains and forming an amylopectin-TA hydrogel.

### Example 3

### SiOₓ-Graphite Electrodes with Hydrogel Binders

The hydrogel binder prepared according to the procedure of Example 2 was used in different cells each comprising a SiOₓ-graphite electrode and a lithium metal counter electrode on a copper current collector. The graphite used in the various SiOₓ-graphite electrodes was SCMG™ from Showa Denko. Electrodes with different SiOₓ to graphite ratios were prepared (about 5 wt. %, about 10 wt. %, about 25 wt. % and about 50 wt. %).

The SiOₓ-graphite electrode materials were prepared by mixing the solids (i.e. the SiOₓ, the SCMG™ and the electronically conductive material) at 2 000 rpm for 30 s. The PVOH-TA aqueous binder solution (from Example 2(a)) was then added to the different solid mixtures. The different mixtures were then mixed 3 times at 2 000 rpm for 1 min each time. Water was then added in 3 portions to the different mixtures to obtain different slurries having an appropriate viscosity. After each water addition, the slurries were mixed at 2 000 rpm for 1 min. The slurries obtained were then each cast on copper current collectors using the Doctor blade method and dried at a temperature of 80° C. for 15 min.

TABLE 1
Electrode material weight concentration
for the 50 wt. % ratio (SiOₓ:Gr of 50:50)

| | Concentration | Composition | Weight |
|---|---|---|---|
| Material | wt. % | wt. % | g |
| SCMG ™ | 100 | 46.5 | 5.00 |
| SiOₓ | 100 | 46.5 | 5.00 |
| Ketjen ™ black | 100 | 1.0 | 0.11 |
| VGCF | 100 | 1.0 | 0.11 |
| PVOH-TA* | 12 | 5.0 | 4.48 |
| Water | 100 | 0 | 5.00 |

*PVOH-TA aqueous binder solution from Example 2(a)

TABLE 2
Electrode material weight concentration
for the 25 wt. % ratio (SiOₓ:Gr of 25:75)

| | Concentration | Composition | Weight |
|---|---|---|---|
| Material | wt. % | wt. % | g |
| SCMG ™ | 100 | 69.7 | 12.00 |
| SiOₓ | 100 | 23.3 | 4.00 |
| Ketjen ™ black | 100 | 1.0 | 0.17 |
| VGCF | 100 | 1.0 | 0.17 |
| PVOH-TA* | 12 | 5.0 | 7.17 |
| Water | 100 | 0 | 5.00 |

*PVOH-TA aqueous binder solution from Example 2(a)

TABLE 3
Electrode material weight concentration
for the 10 wt. % ratio (SiOₓ:Gr of 10:90)

| | Concentration | Composition | Weight |
|---|---|---|---|
| Material | wt. % | wt. % | g |
| SCMG ™ | 100 | 83.7 | 15.00 |
| SiOₓ | 100 | 9.3 | 1.67 |
| Ketjen ™ black | 100 | 1.0 | 0.18 |
| VGCF | 100 | 1.0 | 0.18 |
| PVOH-TA* | 12 | 5.0 | 7.47 |
| Water | 100 | 0 | 4.50 |

*PVOH-TA aqueous binder solution from Example 2(a)

TABLE 4
Electrode material weight concentration
for the 5 wt. % ratio (SiOₓ:Gr of 5:95)

| | Concentration | Composition | Weight |
|---|---|---|---|
| Material | wt. % | wt. % | g |
| SCMG ™ | 100 | 88.3 | 12.00 |
| SiOₓ | 100 | 4.7 | 0.64 |
| Ketjen ™ black | 100 | 1.0 | 0.14 |
| VGCF | 100 | 1.0 | 0.14 |
| PVOH-TA* | 12 | 5.0 | 7.47 |
| Water | 100 | 0 | 2.50 |

*PVOH-TA aqueous binder solution from Example 2(a)

All electrodes had a mass loading in the range of from about 8.0 to about 10.0 mg/cm² and an electrode volumetric mass density in the range of from about 1.2 to about 1.4 g/cm³.

Reference electrodes comprising a 5 wt. % concentration of PVdF (M.W. ˜9400 g/mol) as binder in N-methyl-2-pyrrolidone (NMP) were prepared for comparative purposes. The reference electrodes were prepared in the same weight ratios detailed in Tables 1 to 4, simply replacing the PVOH-TA aqueous binder solution with the PVdF binder.

### Example 4

### Electrochemical Properties

Tables 5 to 7 respectively present the weight concentrations of the electrochemically active materials E1 to E3, the weight concentrations of hydrogel binder B1 to B6, and electrode composition for each of Cells 1 to 15. These will be referred when discussing electrochemical properties measured in this example.

TABLE 5
Electrochemically active material weight concentrations

| Electrochemically | | |
|---|---|---|
| active material | SiOₓ | SCMG ™ |
| E1 | 50 wt. % | 50 wt. % |
| E2 | 25 wt. % | 75 wt. % |
| E3 | 10 wt. % | 90 wt. % |

TABLE 6
Hydrogel binder weight concentrations

| Hydrogel | Hydrogel binder composition | | |
|---|---|---|---|
| binder | Polymer | Polyphenol | Solvent |
| B1 | PVdF | — | NMP |
| | (5 wt. %) | | (95 wt. %) |
| B2 (from | Amylopectin | TA | Water |
| Example 2(f)) | (7 wt. %) | (1 wt. %) | (92 wt. %) |
| B3 (from | PVOH | TA | Water |
| Example 2(a)) | (10 wt. %) | (2 wt. %) | (88 wt. %) |
| B4 (from | PAA | TA | Water |
| Example 2(d)) | (10 wt. %) | (5 wt. %) | (85 wt. %) |
| B5 (from | random | TA | Water (64 wt. %)/ |
| Example 2(b)) | P(HEMA-AA) | (4 wt. %) | Ethanol (20 wt. %) |
| | (12 wt. %) | | |
| B6 (from | bloc P(HEMA-AA) | TA | Water (64 wt. %)/ |
| Example 2(c)) | (12 wt. %) | (4 wt. %) | Ethanol (20 wt. %) |

TABLE 7
Electrode material composition in Cells 1 to 15

| | | | electronically | |
|---|---|---|---|---|
| | | | conductive material | |
| | Electrochemically | | Ketjen ™ | |
| Cell | active material | Binder | black | VGCF |
| Cell 1 | E1 | B1 | (1 wt. %) | (1 wt. %) |
| | (93 wt. %) | (5 wt. %) | | |
| Cell 2 | E1 | B2 | (1 wt. %) | (1 wt. %) |
| | (93 wt. %) | (5 wt. %) | | |
| Cell 3 | E1 | B3 | (1 wt. %) | (1 wt. %) |
| | (93 wt. %) | (5 wt. %) | | |
| Cell 4 | E2 | B1 | (1 wt. %) | (1 wt. %) |
| | (93 wt. %) | (5 wt. %) | | |
| Cell 5 | E2 | B3 | (1 wt. %) | (1 wt. %) |
| | (93 wt. %) | (5 wt. %) | | |
| Cell 6 | E2 | B4 | (1 wt. %) | (1 wt. %) |
| | (93 wt. %) | (5 wt. %) | | |
| Cell 7 | E2 | B2 | (1 wt. %) | (1 wt. %) |
| | (93 wt. %) | (5 wt. %) | | |
| Cell 8 | E3 | B1 | (1 wt. %) | (1 wt. %) |
| | (93 wt. %) | (5 wt. %) | | |
| Cell 9 | E3 | B3 | (1 wt. %) | (1 wt. %) |
| | (93 wt. %) | (5 wt. %) | | |
| Cell 10 | E3 | B4 | (1 wt. %) | (1 wt. %) |
| | (93 wt. %) | (5 wt. %) | | |
| Cell 11 | E1 | B5 | (1 wt. %) | (1 wt. %) |
| | (93 wt. %) | (5 wt. %) | | |
| Cell 12 | E1 | B6 | (1 wt. %) | (1 wt. %) |
| | (93 wt. %) | (5 wt. %) | | |
| Cell 13 | E2 | B5 | (1 wt. %) | (1 wt. %) |
| | (93 wt. %) | (5 wt. %) | | |
| Cell 14 | E2 | B6 | (1 wt. %) | (1 wt. %) |
| | (93 wt. %) | (5 wt. %) | | |
| Cell 15 | E3 | B5 | (1 wt. %) | (1 wt. %) |
| | (93 wt. %) | (5 wt. %) | | |
| Cell 16 | E3 | B6 | (1 wt. %) | (1 wt. %) |
| | (93 wt. %) | (5 wt. %) | | |

All cells were assembled with standard stainless-steel coin cell casings, polyethylene-polyethylene terephthalate-polyethylene (PE/PET/PE)-based separators impregnated with a 1 M LiPF₆ solution in EC/EMC/DEC (4:3:3) and 5% FEC as a liquid electrolyte, SiOₓ-graphite electrodes and lithium metal counter electrodes on copper current collectors.

a) Electrode Material Weight Concentration for the 50 wt. % Ratio

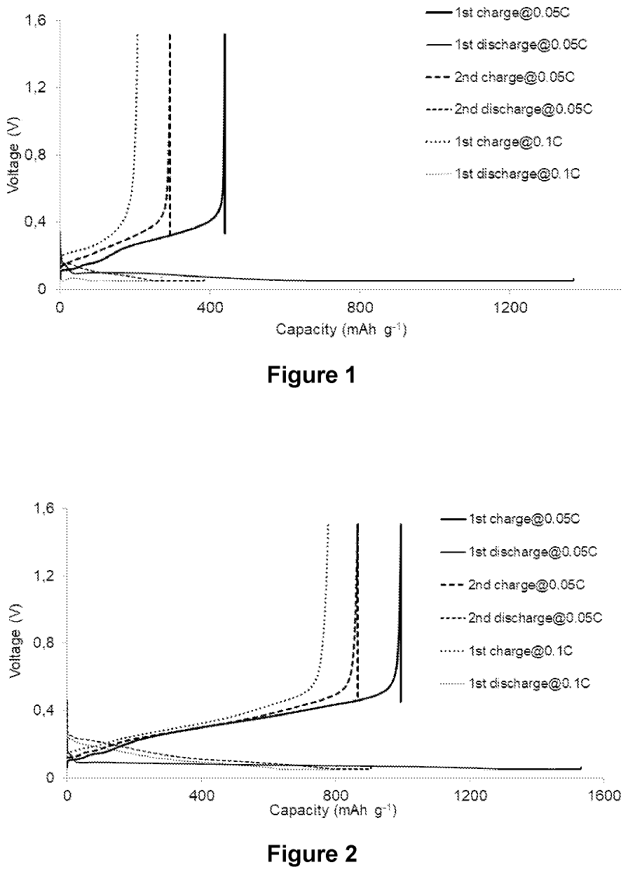

The influence of the water-soluble polymeric binder selection and the presence of a polyphenol in the hydrogel binder is demonstrated in FIGS. 1 to 4, 17 and 18. For the 50 wt. % Si ratio the expected capacity was 1036 mAh g⁻¹.

FIG. 1 displays three charge and discharge cycles for Cell 1 (comparative cell). The first (solid line), second (dashed line) and third (dotted line) cycles were performed respectively at 0.05 C, 0.05 C and 0.1 C (dotted line) at a temperature of 25° C. FIG. 1 shows a capacity significantly lower than the expected capacity and a significant capacity loss with cycling.

FIG. 2 displays three charge and discharge cycles for Cell 2 The first (solid line), second (dashed line) and third (dotted line) cycles were performed respectively at 0.05 C, 0.05 C and 0.1 C at a temperature of 25° C. Although, not as significant as in FIG. 1 a small capacity loss may also be observed with cycling. Furthermore, the capacity is slightly lower than the expected capacity. These results effectively demonstrate that a hydrogel binder comprising amylopectin and TA may be a suitable binder choice for silicon-graphite composite electrodes.

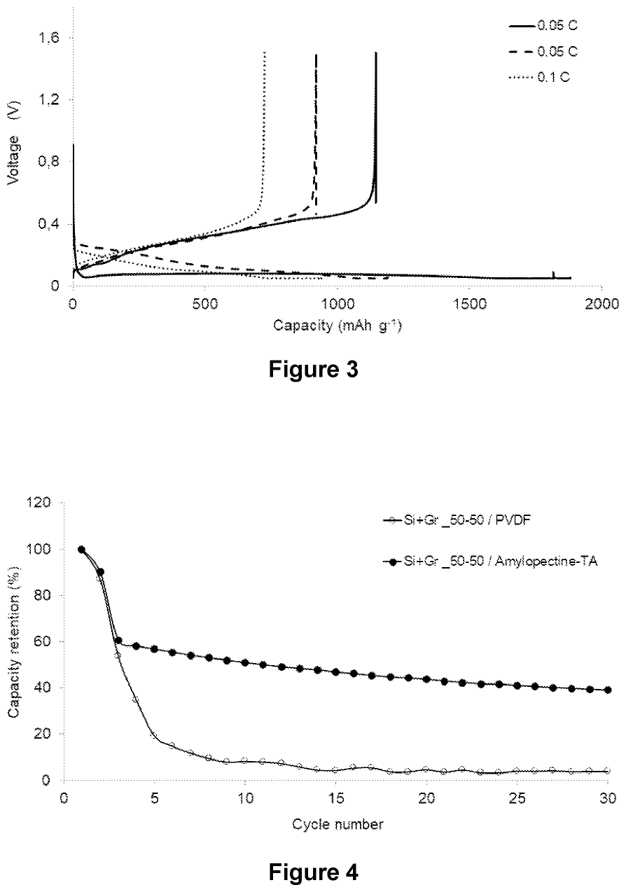

FIG. 3 displays three charge and discharge cycles for Cell 3. The first (solid line), second (dashed line) and third (dotted line) cycles were performed respectively at 0.05 C, 0.05 C and 0.1 C at a temperature of 25° C. Although, not as significant as in FIG. 1 a small capacity loss may also be observed with cycling. Moreover, the capacity is close to the expected capacity, effectively showing that a hydrogel binder comprising PVOH and TA may be a suitable binder choice for silicon-graphite composite electrodes.

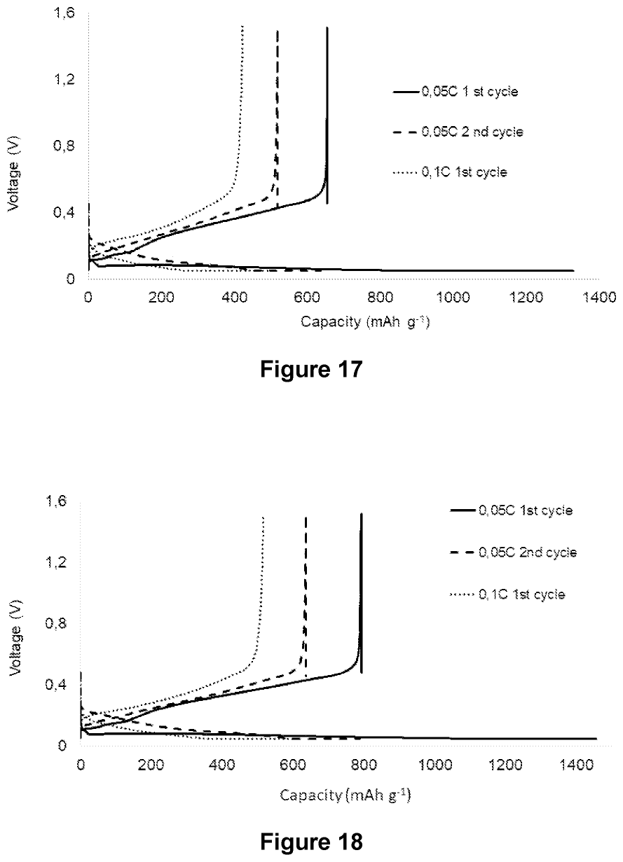

FIG. 17 displays three charge and discharge cycles for Cell 11. The first (solid line), second (dashed line) and third (dotted line) cycle were performed respectively at 0.05 C, 0.05 C and 0.1 C (dotted line) at a temperature of 25° C. Cell 11 comprises a hydrogel binder as prepared in Example 2(b) including the random poly(2-hydroxyethyl methacrylate-co-acrylic acid) copolymer as prepared in Example 1(a) and TA. Similar to FIGS. 1 to 3, a capacity loss may also be observed in FIG. 17 with cycling. However, in comparison with Cell 1, Cell 11 has a capacity significantly closer to the expected capacity. These results effectively show that a hydrogel binder comprising a random poly(2-hydroxyethyl methacrylate-co-acrylic acid) copolymer and TA may be a suitable binder choice for silicon-graphite composite electrodes.

FIG. 18 displays three charge and discharge cycles for Cell 12. The first (solid line), second (dashed line) and third (dotted line) cycles were performed respectively at 0.05 C, 0.05 C and 0.1 C at a temperature of 25° C. Cell 12 comprises a hydrogel binder as prepared in Example 2(c) including the bloc poly(2-hydroxyethyl methacrylate-co-acrylic acid) copolymer as prepared in Example 1(b) and TA. In comparison with Cell 1, Cell 12 has also a capacity significantly closer to the expected capacity, effectively showing that a hydrogel binder comprising a bloc poly(2-hydroxyethyl methacrylate-co-acrylic acid) copolymer and TA may also be a suitable binder choice for silicon-graphite composite electrodes.

FIG. 4 is a graph of the capacity retention (%) versus the number of cycles for Cell 1 (white circle line) and for Cell 2 (black circle line). FIG. 4 shows a significant loss in capacity retention when cycling with a PVdF binder (Cell 1). A loss in capacity retention when cycling with a binder comprising amylopectin and TA may also be observed. However, the loss is less significant with Cell 2 than with Cell 1, effectively showing that amylopectin with TA may be a good binder candidate for silicon-graphite composite electrode.

b) Electrode Material Weight Concentration for the 25 wt. % Ratio

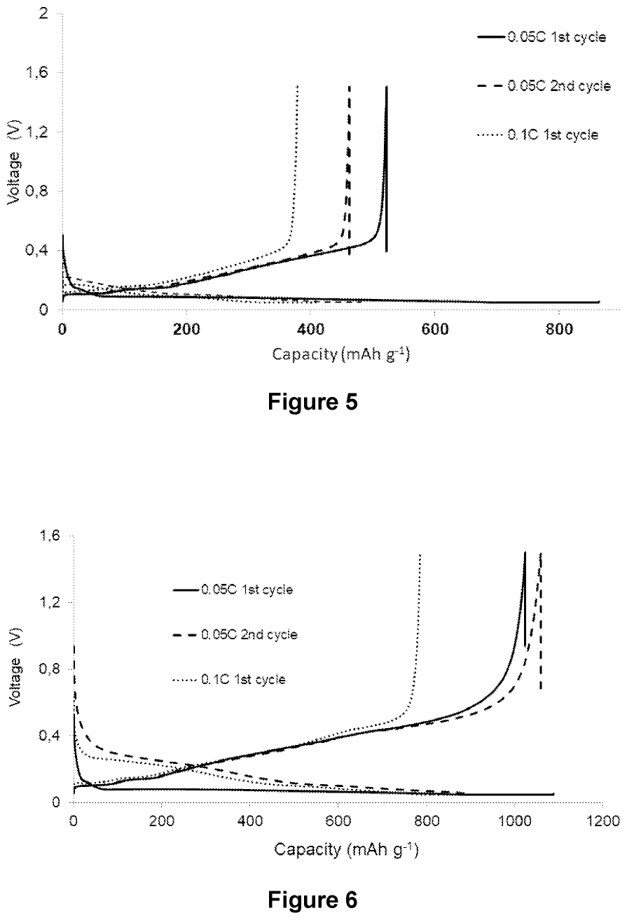

The influence of TA and the water-soluble polymer is further demonstrated in FIGS. 5 to 8, 19 and 20. For the 25 wt. % Si ratio the expected capacity was 704 mAh g⁻¹.

FIG. 5 displays three charge and discharge cycles for Cell 4 which was prepared for comparative purposes without TA. The first (solid line), second (dashed line) and third (dotted line) cycles were performed respectively at 0.05 C, 0.05 C and 0.1 C at a temperature of 25° C. FIG. 5 shows a capacity significantly lower than the expected capacity and significant capacity loss with cycling.

The influence of the presence of TA in the binder is demonstrated in FIG. 6 which displays three charge and discharge cycles for Cell 5. The first (solid line), second (dashed line) and third (dotted line) cycles were performed respectively at 0.05 C, 0.05 C and 0.1 C at a temperature of 25° C. FIG. 6 shows a higher capacity than that of Cell 4.

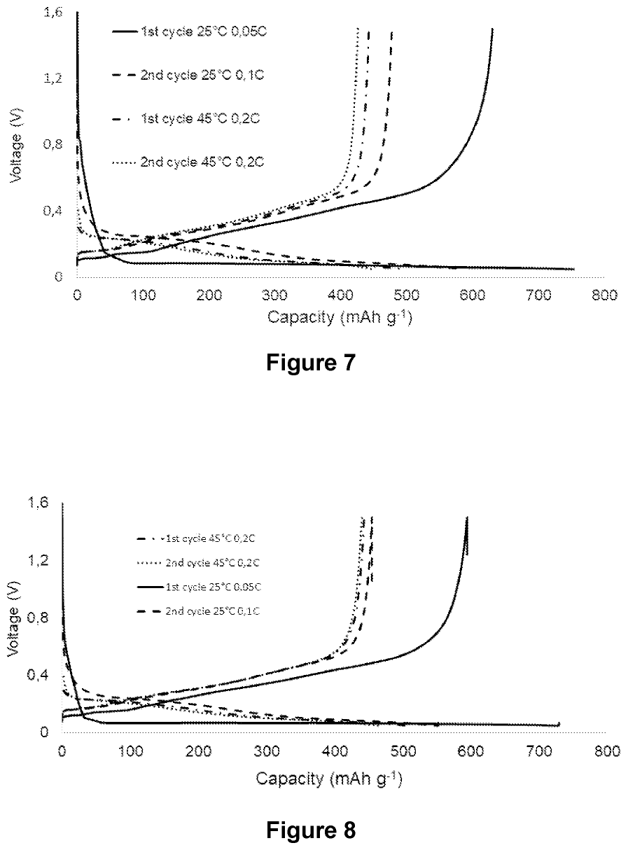

The influence of TA in the binder is also demonstrated in FIG. 7 which displays four charge and discharge cycles for Cell 6. The first cycle (solid line) was performed at 0.05 C at a temperature of 25° C., the second cycle (dashed line) was carried out at 0.1 C at a temperature of 25° C., the third cycle (dash dot line) was performed at 0.2 C at a temperature of 45° C. and the fourth cycle (dotted line) was carried out at 0.2 C at a temperature of 45° C. FIG. 7 shows that after the first cycle the capacity loss becomes less significant.

The influence of the TA is further demonstrated in FIG. 8 which displays four charge and discharge cycles for Cell 7. The first cycle (solid line) was carried out at 0.05 C at a temperature of 25° C., the second cycle (dashed line) was performed at 0.1 C at a temperature of 25° C., the third cycle (dash dot line) was carried out at 0.2 C at a temperature of 45° C. and the fourth cycle (dotted line) was performed at 0.2 C at a temperature of 45° C. FIG. 8 shows that after the first cycle the capacity loss becomes less significant. The influence of temperature is also demonstrated.

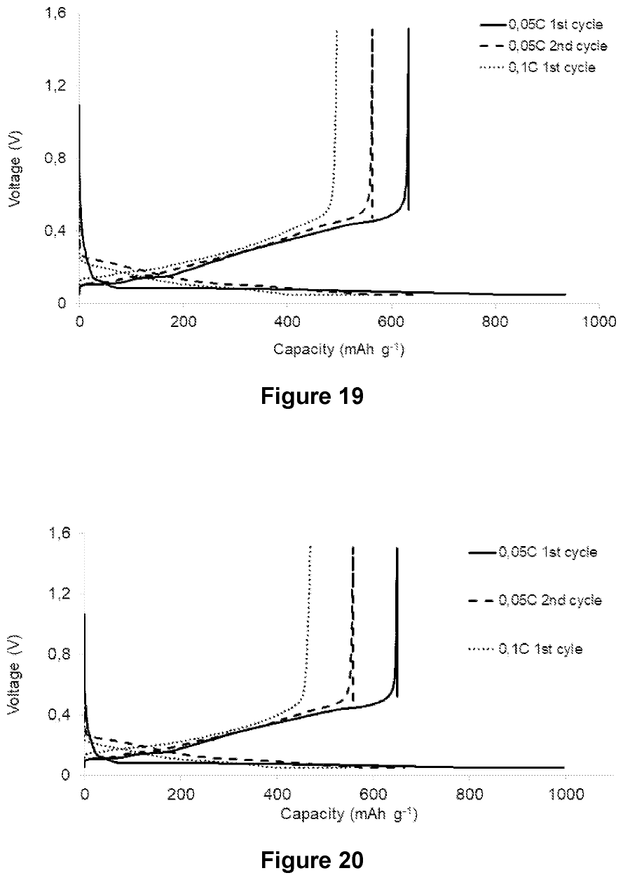

FIG. 19 displays three charge and discharge cycles for Cell 13. The first (solid line), second (dashed line) and third (dotted line) cycles were performed respectively at 0.05, 0.05 C and 0.1 C (dotted line) at a temperature of 25° C.

FIG. 20 displays three charge and discharge cycles for Cell 14. The first (solid line), second (dashed line) and third (dotted line) cycles were performed respectively at 0.05, 0.05 C and 0.1 C at a temperature of 25° C.

c) Electrode Material Weight Concentration for the 10 wt. % Ratio

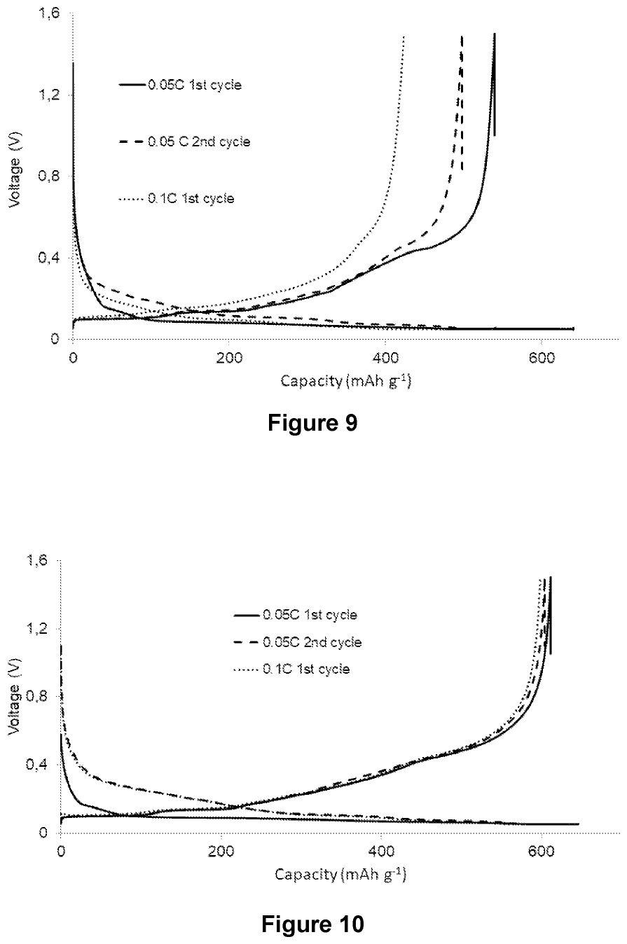

The influence of the TA and the water-soluble polymer is further demonstrated in FIGS. 9 to 11, 21 and 22. For the 10 wt. % Si ratio the expected capacity was 505 mAh g⁻¹.

FIG. 9 displays three charge and discharge cycles for Cell 8 prepared for comparative purposes without TA. The first (solid line), second (dashed line) and third (dotted line) cycles were performed respectively at 0.05 C, 0.05 C and 0.1 C at a temperature of 25° C. FIG. 9 shows a significant capacity loss with cycling.

FIG. 10 displays three charge and discharge cycles for Cell 9. The first (solid line), second (dashed line) and third (dotted line) cycles were at 0.05 C, 0.05 C, 0.1 C at a temperature of 25° C. FIG. 10 shows no significant capacity loss with cycling. Effectively showing that a binder comprising PVOH and TA may be a suitable binder candidate for silicon-graphite composite electrodes.

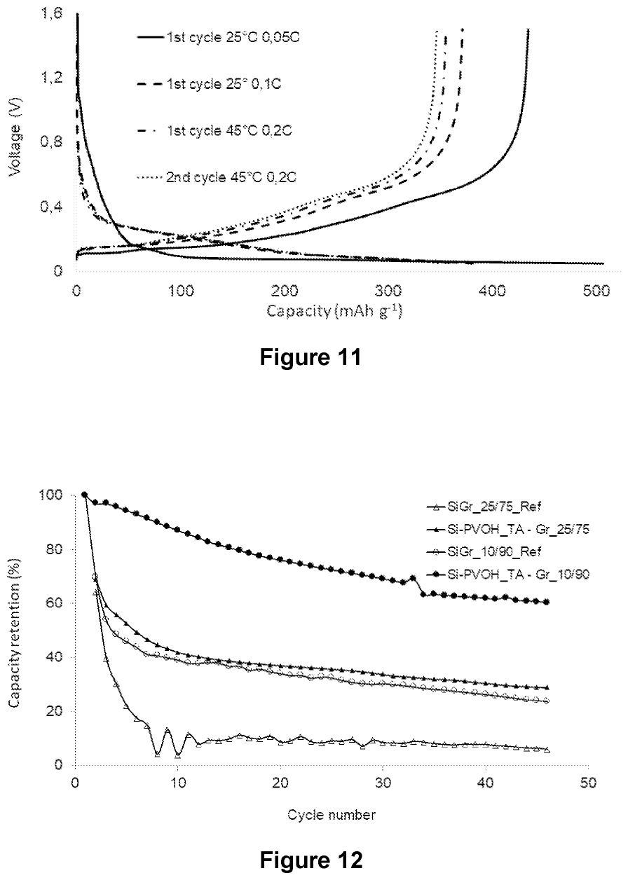

FIG. 11 displays four charge and discharge cycles for Cell 10. The first cycle was carried out at 0.05 C (solid line) at a temperature of 25° C., the second cycle was performed at 0.1 C (dashed line) at a temperature of 25° C., the third cycle was carried out at 0.2 C (dash dot line) at a temperature of 45° C. and the fourth cycle was performed at 0.2 C (dotted line) at a temperature of 45° C. FIG. 11 shows that after the first cycle the capacity loss becomes less significant. The influence of the temperature is also demonstrated.

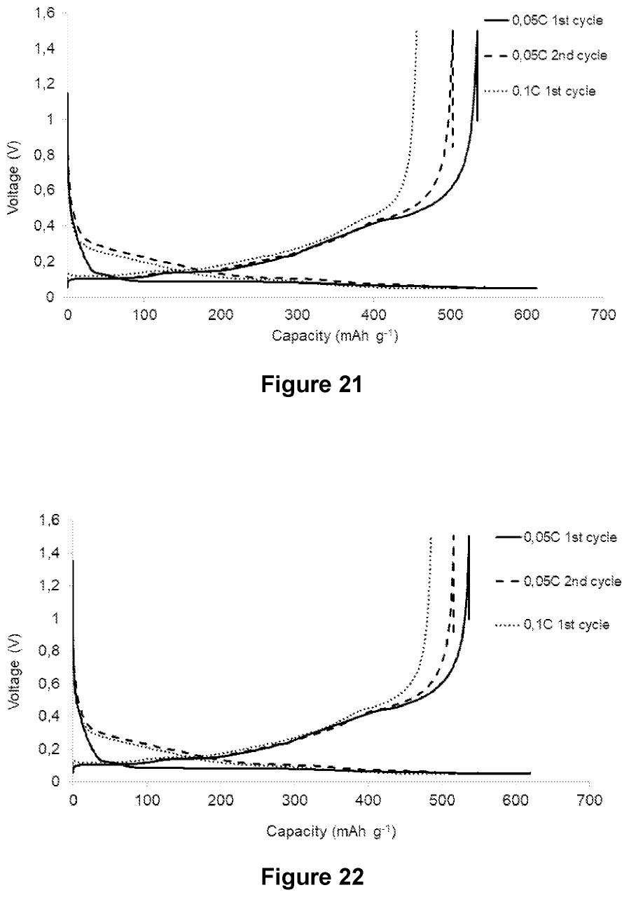

FIG. 21 displays three charge and discharge cycles for Cell 15, the first (solid line), second (dashed line) and third (dotted line) cycles were 0.05 C, 0.05 C and 0.1 C at a temperature of 25° C. In comparison with Cell 13 (FIG. 19) and Cell 11 (FIG. 17), Cell 15 has a lower capacity. However, Cell 15 has a lower capacity loss with cycling.

FIG. 22 displays three charge and discharge cycles, the first (solid line), second (dashed line) and third (dotted line) cycles were at 0.05 C, 0.05 C and 0.1 C at a temperature of 25° C. for Cell 16. In comparison with Cell 14 (FIG. 20) and Cell 12 (FIG. 18), Cell 16 has a lower capacity. However, Cell 16 has an improved capacity retention with cycling compared to the other two (i.e., Cells 14 and 12).

d) PVOH Capacity Retention (%) Versus the Number of Cycles

The effect of TA and of the electrochemically active material composition on capacity retention is demonstrated in FIG. 12. FIG. 12 displays a graph representing the capacity retention (%) versus the number of cycles for Cell 4 (white triangle line), Cell 5 (black triangle line), Cell 8 (white circle line) and for Cell 9 (black circle line). FIG. 12 effectively demonstrates that the presence of TA positively influences the capacity retention with cycling. FIG. 12 also establishes that lower wt. % of Si in the electrochemically active material results in improved capacity retention.

e) PVOH Capacity (mAh/g) Versus the Number of Cycles

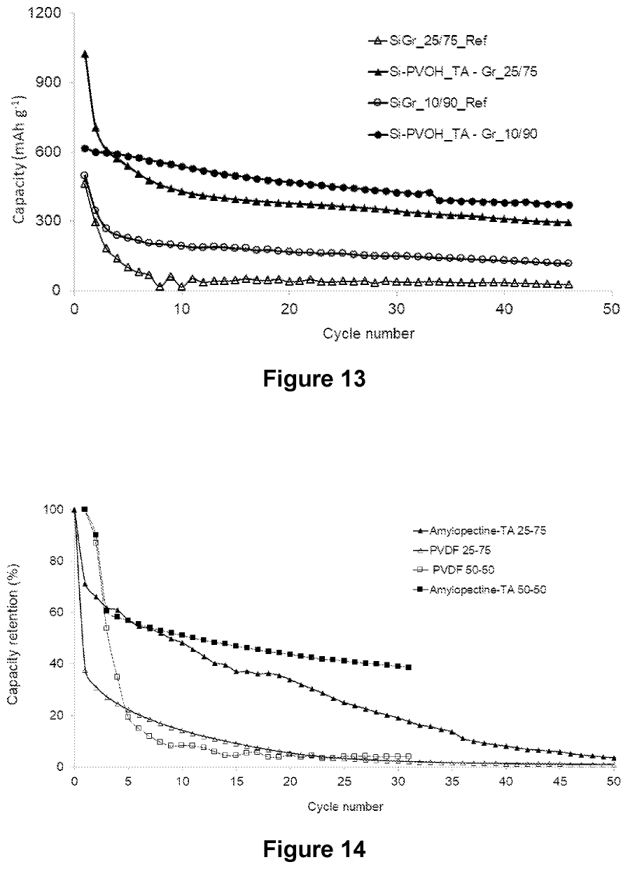

The influence of TA and of the electrochemically active material composition on capacity is demonstrated in FIG. 13. FIG. 13 displays a graph representing the capacity (mAh g⁻¹) versus the number of cycles for Cell 4 (white triangle line), Cell 5 (black triangle line), Cell 8 (white circle line) and for Cell 9 (black circle line). FIG. 13 effectively demonstrate that the presence of TA in the binder positively influences the capacity.

f) Amylopectin-TA Capacity Retention (%) Versus the Number of Cycles

FIG. 14 displays the capacity retention (%) as a function of the number of cycles for Cell 7 (black triangle line), for Cell 4 (white triangle line), for Cell 1 (white square line) and for Cell 2 (black square line). As expected, the capacity retention (%) decrease more rapidly with increasing content (wt. %) in SiOₓ in the electrochemically active material composition. The presence of TA in the hydrogel binder positively influences the capacity.

g) Amylopectin-TA Capacity (mAh/g) Versus the Number of Cycles

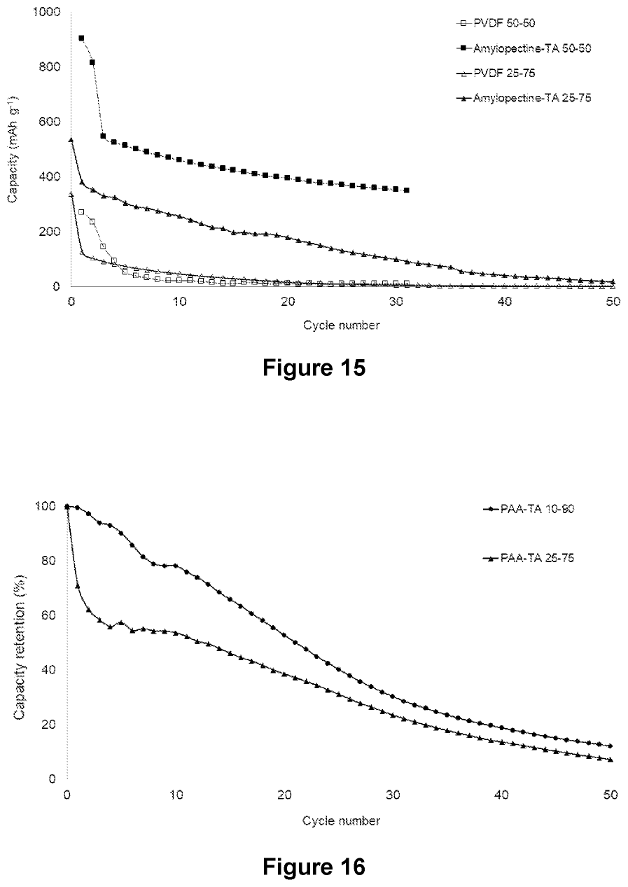

Capacity (mAh/g) measured as a function of the number of cycles for Cell 1 (white square line), for Cell 2 (black square line), for Cell 4 (white triangle line), and for Cell 7 (black triangle line) is shown in FIG. 15. These results demonstrate that the presence of TA in the binder positively influences the capacity. The capacity decreases with increasing (wt. %) of SiOₓ in the electrochemically active material composition, which is expected.

h) PAA-TA Capacity Retention (%) Versus the Number of Cycles

FIG. 16 displays the capacity retention (%) versus the number of cycles for Cell 10 (black circle line), and for Cell 6 (black triangle line). As expected, the capacity retention (%) decrease more drastically with increasing (wt. %) of SiOₓ in the electrochemically active material composition.

Numerous modifications could be made to any of the embodiments described above without distancing from the scope of the present invention. Any references, patents or scientific literature documents referred to in the present application are incorporated herein by reference in their entirety for all purposes.

1. A polymer comprising monomeric units from the polymerization of compounds of Formulae I and II: 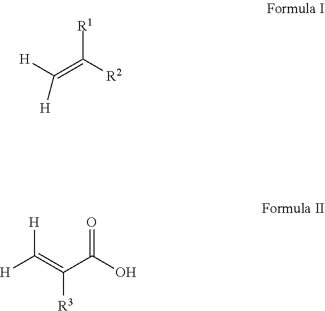
wherein,
R¹ is independently in each occurrence selected from —OH and a OH-containing group such a an optionally substituted C₁₋₆alkyl-OH or —CO₂C₁₋₆alkyl-OH; and
R² and R³ are each independently in each occurrence selected from a hydrogen atom and an optionally substituted C₁₋₆alkyl;
wherein said polymer is preferably an alternating, a random or a block copolymer, and more preferably a random copolymer or a block copolymer.

2. The polymer of claim 1, wherein said polymer is a copolymer of Formula Ill: 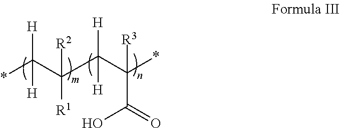
wherein,
R¹, R² and R³ are as defined in claim 1; and
n and m are integers selected such that the number average molecular weight is from about 2 000 g/mol to about 250 000 g/mol, preferably the number average molecular weight is from about 10 000 g/mol to about 200 000 g/mol, or from about 25 000 g/mol to about 200 000 g/mol, or from about 25 000 g/mol to about 150 000 g/mol, or from about 50 000 g/mol to about 150 000 g/mol, or from about 75 000 g/mol to about 125 000 g/mol, limits included.

3-6. (canceled)

7. An electrode material comprising:
the polymer as defined in claim 1, an electrochemically active material, optionally a binder and optionally a polyphenol, preferably wherein the binder comprises the polymer and/or the polyphenol; or
(II) an electrochemically active material, amylopectin, optionally a binder and optionally a polyphenol, preferably wherein the binder comprises the amylopectin and/or the polyphenol; or
(III) an electrochemically active material and a hydrogel binder, said hydrogel binder comprising a water-soluble polymeric binder and a polyphenol.

8-13. (canceled)

14. The electrode material of claim 7, wherein the electrode material is as defined in (III) and the water-soluble polymeric binder:
preferably comprises a functional group selected from the group consisting of carboxyl group, carbonyl group, ether groups, amine groups, amide groups, and hydroxyl group; or
is a homopolymer or a copolymer, preferably an alternating copolymer, a random copolymer or a block copolymer, and more preferably a random copolymer or a block copolymer; or
has a number average molecular weight from about 2 000 g/mol to about 400 000 g/mol, or from about 2 000 g/mol to about 250 000 g/mol, or from about 25 000 g/mol to about 240 000 g/mol, or from about 27 000 g/mol to about 240 000 g/mol, limits included; or
comprises monomeric units of Formula V: 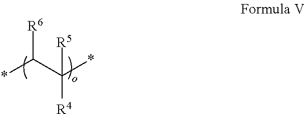
wherein,
R⁴ is independently in each occurrence selected from —CO₂H, —OH, an optionally substituted —CO₂C₁₋₆alkyl, an optionally substituted C₅₋₆ heterocycloalkyl, an optionally substituted —OC₁₋₆alkyl and a OH-containing functional group such as an optionally substituted —C₁₋₆alkyl-OH or —CO₂C₁₋₆alkyl-OH;
R⁵ is independently in each occurrence selected from a hydrogen atom and an optionally substituted C₁₋₆alkyl;
R⁶ is independently in each occurrence selected from a hydrogen atom and an optionally substituted C₁₋₆alkyl; and
o is an integer selected such that the number average molecular weight is from about 2 000 g/mol to about 400 000 g/mol, or from about 2 000 g/mol to about 250 000 g/mol, or from about 25 000 g/mol to about 240 000 g/mol, or from about 27 000 g/mol to about 240 000 g/mol, limits included; or
is selected from the group consisting of poly(vinyl alcohol) (PVOH), poly(acrylic acid) (PAA), poly(vinylpyrrolidone) (PVP), poly(2-hydroxyethyl methacrylate-co-acrylic acid), poly(vinyl alcohol-co-acrylic acid) and poly(acrylic acid-co-maleic acid) (PAAMA), preferably poly(vinyl alcohol) (PVOH) or poly(acrylic acid) (PAA); or
is selected from the group consisting of polyethylene oxide (PEO), poly(methyl vinyl ether-alt-maleic acid) (PVMEMA), gelatin and polysaccharides, wherein the polysaccharide is preferably selected from the group consisting of amylopectin and alginate, and more preferably amylopectin.

15-27. (canceled)

28. The electrode material of claim 7, wherein the electrode material is as defined in (Ill) and the hydrogel binder comprises between 1 wt. % and 5 wt. % or between 1 wt. % and 3 wt. % of the polyphenol.

29. (canceled)

30. The electrode material of claim 7, wherein the electrochemically active material is a silicon-based electrochemically active material preferably selected from the group consisting of silicon, silicon monoxide (SiO), a silicon suboxide (SiOₓ) and a combination thereof, and more preferably a silicon suboxide (SiOₓ, where x is 0<x<2).

31-32. (canceled)

33. The electrode material of claim 30, wherein the silicon-based electrochemically active material further comprises graphite or graphene, preferably wherein the graphite is an artificial graphite (e.q. SCMG), or wherein the silicon to graphite ratio is up to 50:50 wt. % or between 5:95 wt. % and 95:5 wt. %.

34-36. (canceled)

37. The electrode material of claim 7, wherein the electrode material further comprises an electronically conductive material preferably selected from the group consisting of carbon black, acetylene black, graphite, graphene, carbon fibers, carbon nanofibers, carbon nanotubes, and combinations thereof, preferably wherein the electronically conductive material is a combination of carbon fibers and carbon black, or wherein the carbon fibers are vapor grown carbon fibers (VGCF), or wherein the carbon black is Ketjen™ black.

38-41. (canceled)

42. The electrode material of claim 7, wherein the polyphenol is selected from the group consisting of tannins, catechol, and lignin, or wherein the polyphenol is a polyphenolic macromolecule, preferably the polyphenolic macromolecule is tannic acid.

43-44. (canceled)

45. A binder composition for use in electrode materials, the composition comprising:
a polyphenol preferably selected from the group consisting of tannins, catechol, and lignin, and more preferably tannic acid; and
a water-soluble polymer preferably comprising a functional group selected from the group consisting of a carboxyl group, a carbonyl group, an ether group, an amine group, an amide group and an hydroxyl group, wherein the water-soluble polymer is a homopolymer or a copolymer, preferably wherein the copolymer is an alternating copolymer, a random copolymer or a block copolymer, and more preferably a random copolymer or a block copolymer, or preferably wherein the water-soluble polymer has a number average molecular weight from about 2 000 g/mol to about 400 000 g/mol, or from about 2 000 g/mol to about 250 000 g/mol, or from about 25 000 g/mol to about 240 000 g/mol, or from about 27 000 g/mol to about 240 000 g/mol, limits included;
wherein the binder is preferably a hydrogel binder, or wherein the binder composition comprises between 1 wt. % and 5 wt. % or between 1 wt. % and 3 wt. % of the polyphenol.

46-53. (canceled)

54. The binder composition of claim 45, wherein the water-soluble polymer comprises monomeric units of Formula V: 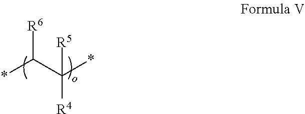
wherein,
R⁴ is independently in each occurrence selected from —CO₂H, —OH, an optionally substituted —CO₂C₁₋₆alkyl, an optionally substituted C₅₋₆ heterocycloalkyl, an optionally substituted —OC₁₋₆alkyl and an optionally substituted —CO₂C₁₋₆alkyl-OH;
R⁵ is independently in each occurrence selected from a hydrogen atom and an optionally substituted C₁₋₆alkyl;
R⁶ is independently in each occurrence selected from a hydrogen atom and an optionally substituted C₁₋₆alkyl; and
o is an integer selected such that the number average molecular weight is from about 2 000 g/mol to about 400 000 g/mol, or from about 2 000 g/mol to about 250 000 g/mol, or from about 25 000 g/mol to about 240 000 g/mol, or from about 27 000 g/mol to about 240 000 g/mol, limits included;
preferably wherein the water-soluble polymer is selected from the group consisting of poly(vinyl alcohol) (PVOH), poly(acrylic acid) (PAA), poly(vinylpyrrolidone) (PVP), poly(2-hydroxyethyl methacrylate-co-acrylic acid), poly(vinyl alcohol-co-acrylic acid) and poly(acrylic acid-co-maleic acid) (PAAMA).

55. (canceled)

56. The binder composition of claim 45, wherein the water-soluble polymer is selected from the group consisting of polyethylene oxide (PEO), poly(methyl vinyl ether-alt-maleic acid) (PVMEMA), gelatin and polysaccharides, preferably the polysaccharide is selected from the group consisting of amylopectin and alginate.

57-61. (canceled)

62. An electrode material comprising the binder composition of claim 45 and an electrochemically active material.

63. An electrode comprising the electrode material as defined in claim 7 on a current collector.

64-65. (canceled)

66. An electrochemical cell comprising a negative electrode, a positive electrode and an electrolyte, wherein at least one of the negative electrode or positive electrode is as defined in claim 63, preferably wherein the negative electrode is as defined in claim 63, and wherein the electrolyte optionally comprises a solvent and a lithium salt.

67-68. (canceled)

69. A battery comprising at least one electrochemical cell as defined in claim 66, preferably said battery is a lithium-ion battery.

70. (canceled)

71. An electrode comprising the electrode material as defined in claim 62 on a current collector.

72. An electrochemical cell comprising a negative electrode, a positive electrode and an electrolyte, wherein at least one of the negative electrode or positive electrode is as defined in claim 71, preferably wherein the negative electrode is as defined in claim 71, and wherein the electrolyte optionally comprises a solvent and a lithium salt.

73. A battery comprising at least one electrochemical cell as defined in claim 72, preferably said battery is a lithium-ion battery.
